(19) United States
(12) Patent Application Publication
(10) Pub. No.: US 2019/0195302 A1
(43) Pub. Date: Jun. 27, 2019

(54) A BUSHING ASSEMBLY FOR SOLAR TRACKING SYSTEMS

(71) Applicant: SCORPIUS TRACKERS PRIVATE LIMITED, Pune (IN)

(72) Inventor: Kiran Navaneet SHAH, Pune (IN)

(21) Appl. No.: 16/302,330

(22) PCT Filed: Mar. 4, 2017
(86) PCT No.: PCT/IB2017/051271

§ 371 Date: Nov. 16, 2018

(30) Foreign Application Priority Data
May 21, 2016 (IN) 201621017574

(51) Int. Cl. F16F 1/38; H02S 20/20

(52) U.S. Cl. CPC F16F 1/38; H02S 20/20

(57) ABSTRACT

The present disclosure relates to the field of busing assemblies in solar tracking systems. The disclosed bushing assembly (100) is easy to assemble and install, and does not require any additional fixtures or clamps to keep the bushing assembly (100) at place. The bushing assembly (100) comprises a housing (110), a resilient bushing (120), and at least one flange (122a). The resilient bushing (120) is disposed within the housing (110), and has at least one slit (124) configured thereon. The slit (124) facilitates deformation of the bushing (120) while inserting the bushing (120) within the housing (110). The slit (124) is parallel or inclined at a predetermined angle with respect to the longitudinal axis (L1) of the bushing (120). The flange (122a) is configured on the periphery of the bushing (120) abutting the housing (110). The flange (122a) restricts an axial movement of the bushing (120).

### FIELD

The present disclosure relates to the field of solar tracking systems. Particularly, the present disclosure relates to the field of bushing assemblies in solar tracking systems.

### BACKGROUND

In a solar tracking system, a plurality of solar panels is attached to a torque tube using purlins or clamps between them. The torque tube is rotated about a single axis throughout the day to track the sun so that the plurality of solar panels can capture the incident solar energy more efficiently. The torque tube needs to be supported as the torque tube is relatively long. Bearings or bushings are used to support the torque tube. A conventional bushing assembly that supports the torque tube, is required to bear vertical and lateral loads imposed by the wind. The bushing is inserted into the housing. The torque tube is inserted into the bushing. To keep the bushing from sliding out of the housing, fixtures or clamps are mounted on the torque tube perpendicular to the operative surface of the bushing. Typically, a clamp is used to contain the bushing within the housing, thereby preventing the bushing from escaping out of the housing as the torque tube rotates. However, additional fixtures, such as the clamp, increase the cost associated with the manufacturing and the installation the bushing assembly.

Therefore, there is felt a need for a bushing assembly that alleviates the abovementioned drawbacks of the conventional bushing assemblies used for solar tracking systems.

### OBJECTS

Some of the objects of the present disclosure, which at least one embodiment herein satisfies, are as follows:

An object of the present disclosure is to provide a bushing assembly that is robust in construction.

Another object of the present disclosure is to provide a bushing assembly that is easy to assemble and install.

Yet another object of the present disclosure is to provide a bushing assembly that is able to take lateral and vertical loads.

Yet another object of the present disclosure is to provide a bushing assembly that does not require any additional fixtures or clamps to keep the bushing assembly in place.

Yet another object of the present disclosure is to provide a busing assembly that is resistant to the entry of dust and sand.

Other objects and advantages of the present disclosure will be more apparent from the following description, which is not intended to limit the scope of the present disclosure.

### SUMMARY

The present disclosure envisages a bushing assembly for solar tracking systems. The bushing assembly comprises a housing, a resilient bushing, and at least one flange. The resilient bushing is disposed within the housing. The resilient bushing has at least one slit configured thereon to facilitate deformation of the resilient bushing while inserting the bushing within the housing. The bushing assembly comprises at least one flange configured on the periphery of the bushing. The at least one flange abuts the housing. Further, the at least one flange restricts an axial movement of the bushing within the housing.

In an embodiment, the bushing has two slits such that the two slits divide the bushing into two portions.

In another embodiment, the bushing assembly comprises two flanges configured at an operative front peripheral surface and an operative rear peripheral surface of the bushing.

In one embodiment, the at least one slit is parallel to the longitudinal axis of the bushing. In another embodiment, the at least one slit is inclined with respect to the longitudinal axis of the bushing at an angle ranging from 10 degrees to 30 degrees.

The resilient bushing is made of a material selected from the group consisting of nylon, phenols, acetal, polyimide, ultra-high-molecular-weight polyethylene (UHMWPE), polysulfone, polypropylene, polyphyenylene sulphide, composite materials, and any combinations thereof.

### BRIEF DESCRIPTION OF THE ACCOMPANYING DRAWING

The bushing assembly for solar tracking systems of the present disclosure will now be described with the help of the accompanying drawing, in which:

FIG. 1 illustrates an isometric view of a bushing assembly, in accordance with an embodiment of the present disclosure;

FIG. 2 illustrates an isometric view of a deformed bushing being inserted within a housing during the assembly of the bushing assembly of FIG. 1;

FIG. 3 illustrates another isometric view of the bushing assembly of FIG. 1;

FIG. 4 illustrates a front view of the bushing assembly of FIG. 1;

FIG. 5 illustrates a bottom view of the bushing assembly of FIG. 1;

FIG. 6 illustrates a rear view of the bushing assembly of FIG. 1;

FIG. 7 illustrates a top view of the bushing assembly of FIG. 1;

FIG. 8 illustrates a side view of the bushing assembly of FIG. 1;

FIG. 9 illustrates an isometric view of the bushing of the bushing assembly of FIG. 1; and

FIG. 10 illustrates an isometric view of the deformed bushing of the bushing assembly of FIG. 1.

### List of Reference Numerals

100—Bushing assembly
110—Housing
111—Body of housing
112—Base of housing
120—Bushing
122a, 122b—Flanges
124—Slit
L1—Longitudinal axis of bushing

### DETAILED DESCRIPTION

The present disclosure envisages a bushing assembly for solar tracking systems that is easy to assemble and does not require any additional fixtures or clamps to keep the bushing assembly at place.

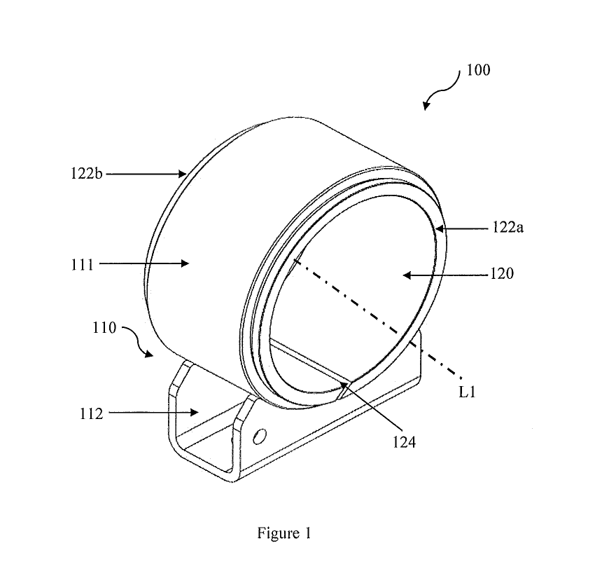

The bushing assembly for solar tracking systems of the present disclosure is described with reference to FIG. 1 through FIG. 10.

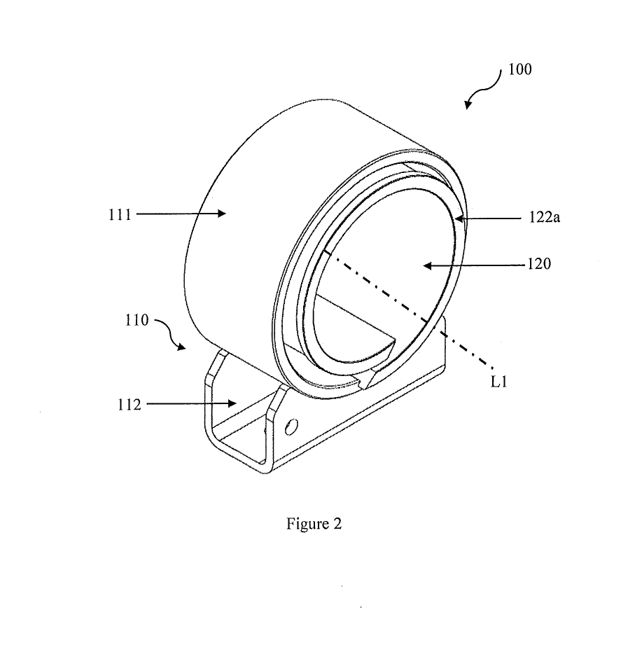

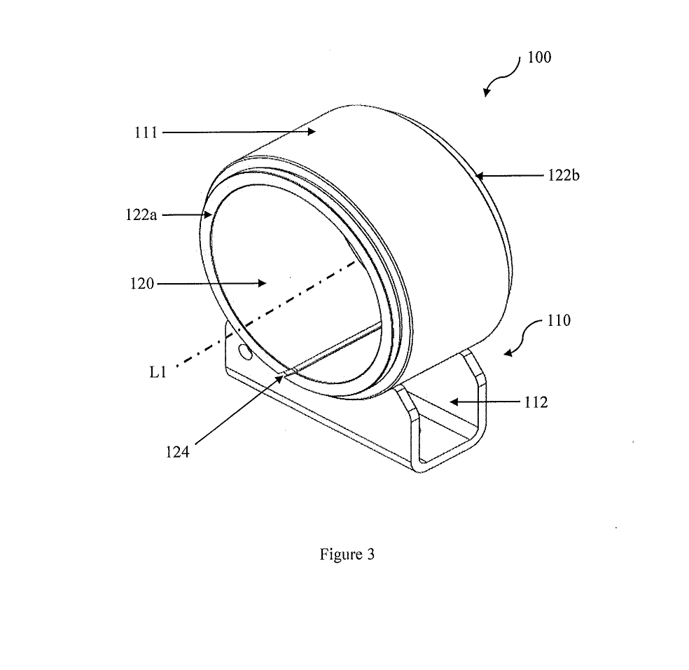

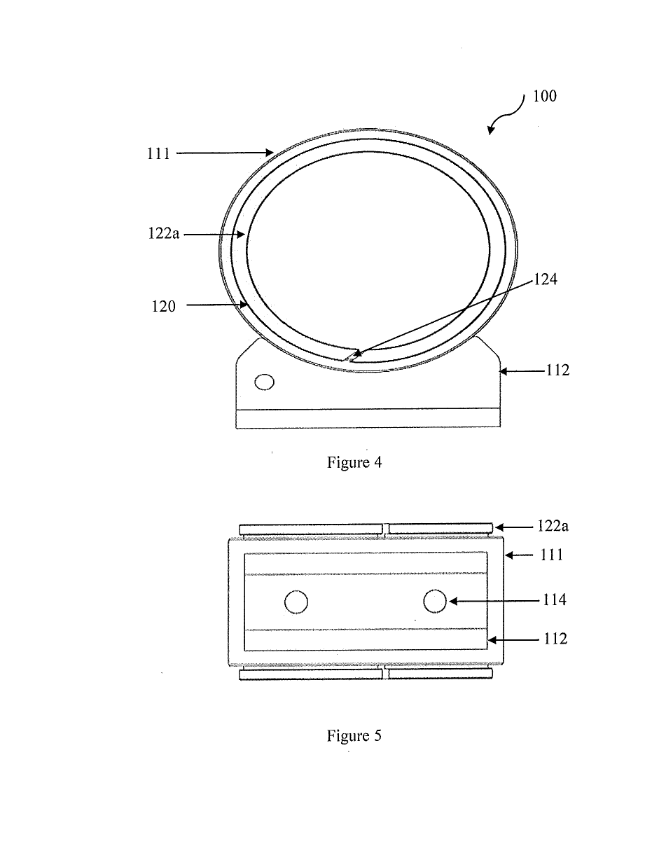

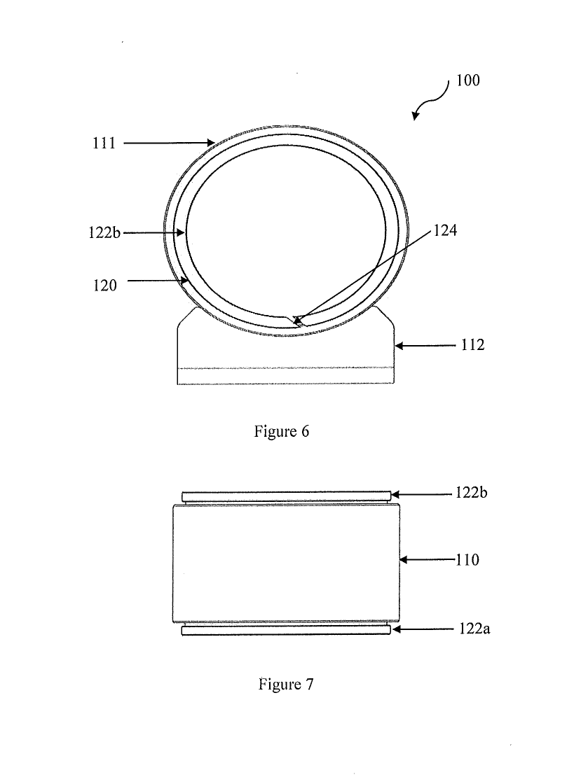

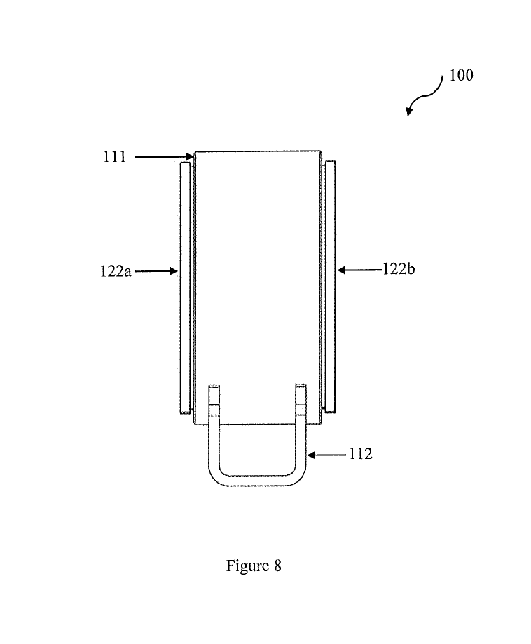

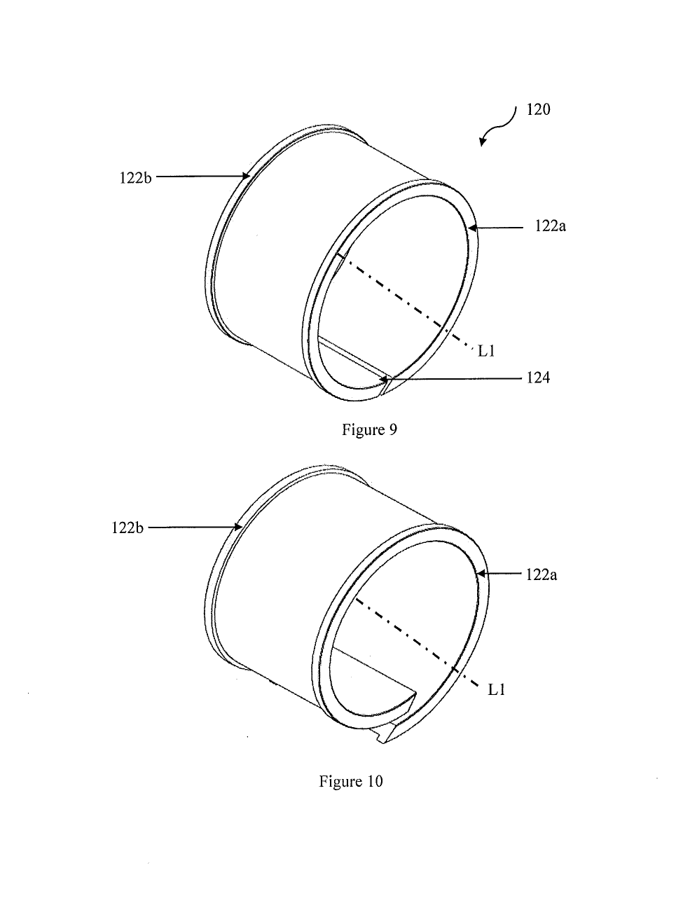

FIG. 1 illustrates an isometric view of a bushing assembly 100, in accordance with an embodiment of the present disclosure. FIG. 2 illustrates an isometric view of a deformed resilient bushing 120 inserted within a housing 110 of the bushing assembly 100 of FIG. 1. FIG. 3 illustrates another isometric view of the bushing assembly 100 of FIG. 1. FIG. 4 illustrates a front view of the bushing assembly 100 of FIG. 1. FIG. 5 illustrates a bottom view of the bushing assembly 100 of FIG. 1. FIG. 6 illustrates a rear view of the bushing assembly 100 of FIG. 1. FIG. 7 illustrates a top view of the bushing assembly 100 of FIG. 1. FIG. 8 illustrates a side view of the bushing assembly 100 of FIG. 1. FIG. 9 illustrates an isometric view of the resilient bushing 120 of the bushing assembly 100 of FIG. 1. FIG. 10 illustrates an isometric view of the deformed resilient bushing 120 of the bushing assembly 100 of FIG. 1.

The bushing assembly comprises the housing 110, the resilient bushing 120 (hereinafter referred to as bushing 120), and at least one flange 122a. The housing 110 is configured to facilitate insertion of the bushing 120 therewithin. In an embodiment, the housing 110 has a circular hollow profile to facilitate insertion of the bushing 120 therewithin. In another embodiment, the housing 110 has a profile formed by assembling multiple parts together to facilitate insertion of the bushing 120 therewithin.

The housing 110 is defined by a housing body 111 and a base 112. The housing body 111 has a hollow profile to accommodate the bushing 120 therewithin. The base 112 is configured to facilitate the mounting of the housing 110 on a pedestal (not shown in figures) that can be fixed into the ground. The housing 110 is mounted on the pedestal using a plurality of fasteners (not shown in figures). In an embodiment, each of the plurality of fasteners is nut and bolt assembly. A plurality of holes 114 (as shown in FIG. 5) is configured on the base 112 of the housing 110 to facilitate the reception of the plurality of fasteners therewithin.

In an embodiment, the base 112 has a U-shaped profile, and is connected to the housing body 111. In one embodiment, the base 112 is connected to the housing body 111 by means of nut and bolt assembly or welding. In another embodiment, the base 112 is formed integral with the housing body 111 by casting, forging or machining process.

The shape of the hollow profile of the housing 110 is complimentary to the shape of the bushing 120 to facilitate easy insertion and snug fitting of the bushing 120 within the housing 110. The cross-sectional shape of the hollow profile of the housing 110 can be selected from the group consisting of a square, a circle, a rectangle, and any geometrical or non-geometrical shape. In a preferred embodiment, the cross-section of the housing 110 has a hollow circular profile.

The housing 110 can be made of a material selected from the group consisting of cast iron, galvanized steel, aluminium, aluminium alloys, and any metallic or non-metallic material. In an embodiment, the material of the housing is steel.

The bushing 120 is disposed within the housing 110. The bushing 120 has a slit 124 configured on the body. The slit 124 facilitates deformation of the bushing 120 while inserting the bushing 120 within the housing 110. Being resilient in nature, the bushing 120 gets deformed while inserting the same within the housing 110, and regains its original shape once properly inserted. The bushing 120 has a hollow profile to permit a torque tube (not shown in figures) to pass therethrough.

The bushing assembly 100 further comprises at least one flange 122a configured on a periphery of the bushing 120. The at least one flange 122a abuts the housing 110 (as shown in figures) to restrict the axial movement of the bushing 120 within the housing 110. In an embodiment, the bushing assembly 100 comprises two flanges 122a, 122b configured at an operative front peripheral surface and at an operative rear peripheral surface of the bushing 120 respectively. The two flanges 122a, 122b completely restrict the axial movement of the bushing 120 within the housing 110, and prevent the bushing 120 from escaping out of the housing 110 after the bushing 120 is inserted into the housing 110 and set to its original shape before deformation. Therefore, the bushing assembly 100 does not require additional fixtures or clamps to keep the bushing assembly at place.

The bushing 120 can be configured as a single part with the single slit 124. In an embodiment, the bushing 120 has two portions forming two slits at the interface. More specifically, the bushing 120 has two slits such that the two slits divide the bushing 120 in equal halves forming two portions.

In one embodiment, the slit 124 is parallel to the longitudinal axis (L1) of the bushing 120. In another embodiment, the slit 124 is inclined with respect to the longitudinal axis (L1) of the bushing 120. Typically, the slit 124 is inclined to the longitudinal axis (L1) of the bushing 120 at an angle ranging from 10 degrees to 30 degrees. The tilted slit does not allow dust to settle therein.

In one embodiment, the outer diameter of the bushing 120 is slightly lesser that the internal diameter of the circular profile of the housing 110 for snugly fitting the bushing 120. In another embodiment, the outer diameter of the two flanges 122a, 122b is equal or smaller than the outer diameter of the circular profile of the housing 110. This arrangement facilitates rotation of the bushing 120 within the housing 110, and prevents the bushing 120 from escaping out or slipping out of the housing 110 during operation or handling.

The bushing 120 fits in snugly after insertion into the housing 110. The two flanges 122a, 122b also fit snugly against the vertical walls of the housing 110. This prevents the entry of dust or sand particles into the bushing assembly 100 during operation.

The bushing 120 can be made of a material selected from the group consisting of nylon, phenols, acetal, polyimide, ultra-high-molecular-weight polyethylene (UHMWPE), polysulfone, polypropylene, polyphyenylene sulphide, composite materials, or any other suitable material.

In an embodiment, carbon black or suitable additives are added to the material selected for manufacturing the bushing 120 to make it resistant to degradation from solar UV radiation. In another embodiment, solid lubricant additives are added to the material. In yet another embodiment, fibers of a suitable material like glass fiber are added to the material selected for moulding or manufacturing the bushing 120. The above three features may be all simultaneously or in part used for manufacturing the bushing 120.

The shape of the inner surface of the bushing 120 is complementary to the shape of the torque tube. The cross-sectional shape of the hollow profile of the bushing 120 can be selected from the group consisting of a square, a circle, a rectangle, and any geometrical or non-geometrical shape. In a preferred embodiment, the bushing 120 has a circular hollow profile.

The aforementioned shapes of the bushing 120 can be configured from any of the common manufacturing processes like machining out of a solid rod or a tube, ram extrusion followed by turning, moulding, casting, forming etc.

In a working configuration, the bushing 120 is deformed at the slit 124, thereby reducing the outer diameter thereof to facilitate the insertion of the bushing 120 within the housing 110. After insertion, the bushing 120 is pressed outwards towards the housing till it regains the original shape. The slit 124 may be fully or partly closed after insertion of the bushing 120 in the housing 110. The two flanges 122a, 122b are positioned at the operative ends of the housing 110 such that the bushing 120 is held in its place within the housing 110. The torque tube is inserted through the bushing 120. A plurality of solar panels (not shown in figures) is mounted on the torque tube using clamps or suitable purlins mounted on the torque tube. The torque tube is rotated throughout the day to track the sun. As the torque tube rotates, the bushing 120 also rotates within the housing.

The bushing assembly 100 is configured to sustain against high wind loads and lateral loads. Further, the bushing assembly 100 does not require any lubrication. As two flanges 122a and 122b are provided at the peripheral ends of the bushing 120, no additional fixtures or clamps are required to hold the bushing 120 within the housing 110.

### Technical Advancements

The present disclosure described herein above has several technical advantages including, but not limited to, the realization of a bushing assembly that:
is robust in construction;
is easy to assemble and install;
does not require any additional fixtures or clamps to keep the bushing assembly at place;
is able to withstand lateral and vertical loads; and
is resistant to the entry of dust and sand.

The disclosure has been described with reference to the accompanying embodiments which do not limit the scope and ambit of the disclosure. The description provided is purely by way of example and illustration.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully revealed the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A bushing assembly (100) for solar tracking systems, said bushing assembly (100) comprising:
a housing (110);
a resilient bushing (120) disposed within said housing (110), said resilient bushing (120) having at least one slit (124) configured thereon to facilitate deformation of said resilient bushing (120) while inserting said resilient bushing (120) within said housing (110); and
at least one flange (122a) configured on the periphery of said bushing (120), said at least one flange (122a) abutting said housing (110) to restrict an axial movement of said bushing (120) within said housing (110).

2. The bushing assembly (100) as claimed in claim 1, wherein said resilient bushing has two slits dividing said resilient bushing into two portions.

3. The bushing assembly (100) as claimed in claim 1, which comprises two flanges (122a, 122b) configured at an operative front peripheral surface and an operative rear peripheral surface of said resilient bushing (120).

4. The bushing assembly (100) as claimed in claim 1, wherein said at least one slit (124) is parallel to the longitudinal axis (L1) of said resilient bushing (120).

5. The bushing assembly (100) as claimed in claim 1, wherein said at least one slit (124) is inclined with respect to the longitudinal axis (L1) of said resilient bushing (120).

6. The bushing assembly (100) as claimed in claim 5, wherein said at least one slit (124) is inclined with respect to the longitudinal axis (L1) of said bushing (120) at an angle ranging from 10 degrees to 30 degrees.

7. The bushing assembly (100) as claimed in claim 1, wherein said resilient bushing (120) is made of a material selected from the group consisting of nylon, phenols, acetal, polyimide, ultra-high-molecular-weight polyethylene (UHMWPE), polysulfone, polypropylene, polyphyenylene sulphide, composite materials, and any combinations thereof.

8. The bushing assembly (100) as claimed in claim 1, wherein said housing (110) is made of a material selected from the group consisting of cast iron, galvanized steel, aluminium, aluminium alloy, and any combinations thereof.

9. The bushing assembly (100) as claimed in claim 1, wherein said housing (110) has:
a hollow body configured to accommodate said bushing (120) therewithin; and
a base (112) configured to facilitate mounting of said housing (110) on a pedestal.

10. The bushing assembly (100) as claimed in claim 9, wherein said hollow body of said housing (110) has a shape complimentary to the shape of said bushing (120).
